(19) United States
(12) Patent Application Publication
(10) Pub. No.: US 2010/0121836 A1
(43) Pub. Date: May 13, 2010

(54) SYSTEM, METHOD, AND COMPUTER-READABLE MEDIUM FOR ELIMINATING UNNECESSARY SELF-JOINS IN A DATABASE SYSTEM

(76) Inventors: Yu Xu, San Diego, CA (US); Olli Pekka Kostamaa, Santa Monica, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/268,491

(22) Filed: Nov. 11, 2008

(51) Int. Cl. G06F 17/30; G06F 7/00

(52) U.S. Cl. 707/713; 707/E17.017

(57) ABSTRACT

A system, method, and computer-readable medium for optimizing query performance in a database system are provided. In one embodiment, join predicates of a self outer join are evaluated. If each join predicate is respectively based on a common join attribute, and each join attribute has a not null constraint applied thereto, the self outer join may be re-written as a self inner join. In another embodiment, if not null and unique constraints are applied to each join attribute of an inner join featuring join predicates each respectively based on a common join attribute, the inner join may advantageously removed thereby resulting in a select operation.

### BACKGROUND

A database is a collection of stored data that is logically related and that is accessible by one or more users or applications. A popular type of database is the relational database management system (RDBMS), which includes relational tables, also referred to as relations, made up of rows and columns (also referred to as tuples and attributes). Each row represents an occurrence of an entity defined by a table, with an entity being a person, place, thing, or other object about which the table contains information.

One of the goals of a database management system is to optimize the performance of queries for access and manipulation of data stored in the database. Given a target environment, an optimal query plan is selected, with the optimal query plan being the one with the lowest cost, e.g., response time, as determined by an optimizer. The response time is the amount of time it takes to complete the execution of a query on a given system.

Database applications, especially business intelligence tools, often produce large and complex SQL queries, some of which can be simplified to equivalent queries for more efficient processing. However, sometimes it is not feasible to request those application providers to produce more efficient queries because it would either require major changes in the applications or special treatment for certain cases.

### SUMMARY

Disclosed embodiments provide a system, method, and computer readable medium for optimizing query performance in a database system. In one embodiment, join predicates of a self outer join are evaluated. If each join predicate is respectively based on a common join attribute, and each join attribute has a not null constraint applied thereto, the self outer join may be re-written as a self inner join. In another embodiment, if not null and unique constraints are applied to each join attribute of an inner join featuring join predicates each respectively based on a common join attribute, the inner join may advantageously removed thereby resulting in a select operation.

### BRIEF DESCRIPTION OF THE DRAWINGS

Aspects of the present disclosure are best understood from the following detailed description when read with the accompanying figures, in which:

FIG. 1 depicts a diagrammatic representation of an exemplary architecture for a large database system that is suited for implementing mechanisms for optimizing queries and eliminating unnecessary self-joins in accordance with disclosed embodiments;

FIG. 2 is a diagrammatic representation of a massively parallel processing system configuration suitable for implementing mechanisms for optimizing query performance and eliminating unnecessary self-joins in accordance with disclosed embodiments;

FIG. 3 is a diagrammatic representation of a parsing engine implemented in accordance with an embodiment;

FIG. 4 is a diagrammatic representation of a parser implemented in accordance with an embodiment;

FIG. 5 is a diagrammatic representation of an exemplary table on which query optimization may be performed in accordance with disclosed embodiments;

FIG. 6 is a flowchart that depicts processing of a conversion routine that rewrites a self outer join to a self inner join in accordance with an embodiment; and

FIG. 7 is a flowchart that depicts processing of a join conversion routine that eliminates unnecessary self inner joins in accordance with another embodiment.

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting.

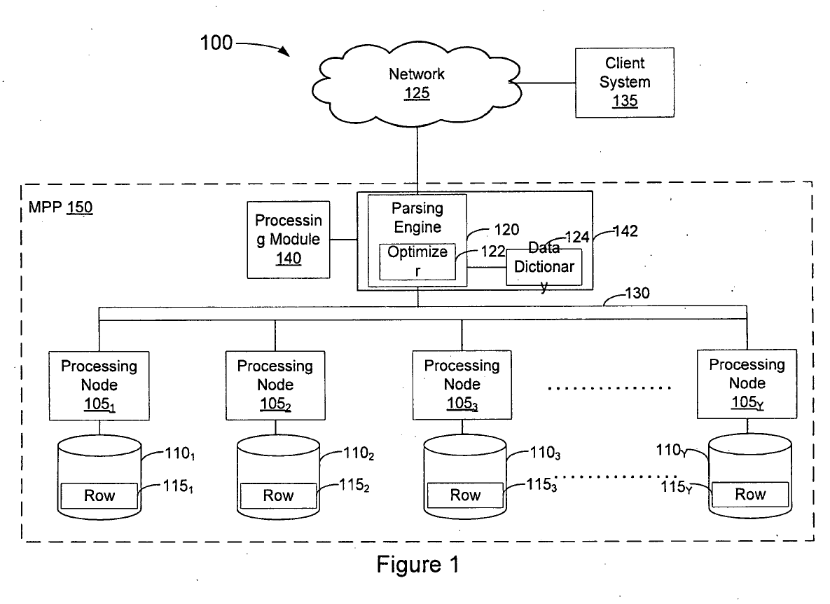

FIG. 1 depicts a diagrammatic representation of an exemplary architecture for a large database system 100, such as a Teradata Active Data Warehousing System, that is suited for implementing mechanisms for optimizing queries and eliminating unnecessary self-joins in accordance with disclosed embodiments. The database system 100 includes a relational database management system (RDBMS) built upon a massively parallel processing (MPP) system 150.

As shown, the database system 100 includes one or more processing nodes 105_{1 . . . Y} that manage the storage and retrieval of data in data-storage facilities 110_{1 . . . Y}. Each of the processing nodes may host one or more physical or virtual processing modules, such as one or more access module processors (AMPs). Each of the processing nodes 105_{1 . . . Y} manages a portion of a database that is stored in a corresponding one of the data-storage facilities 110_{1 . . . Y}. Each of the data-storage facilities 110_{1 . . . Y} includes one or more disk drives or other storage medium.

The system stores data in one or more tables in the data-storage facilities 110_{1 . . . Y}. The rows 115_{1 . . . Y} of the tables are stored across multiple data-storage facilities 110_{1 . . . Y} to ensure that the system workload is distributed evenly across the processing nodes 105_{1 . . . Y}. A parsing engine 120 organizes the storage of data and the distribution of table rows 115_{1 . . . Y} among the processing nodes 105_{1 . . . Y} and accesses processing nodes 105_{1 . . . Y} via an interconnect 130. The parsing engine 120 also coordinates the retrieval of data from the data-storage facilities 110_{1 . . . Y} in response to queries received from a user, such as one using a client computer system 135 connected to the database system 100 through a network 125 connection. The parsing engine 120, on receiving an incoming database query, applies an optimizer 122 component to the query to assess the best plan for execution of the query. Selecting the optimal query-execution plan includes, among other things, identifying which of the processing nodes 105_{1 . . . Y} are involved in executing the query and which database tables are involved in the query, as well as choosing which data-manipulation techniques will serve best in satisfying the conditions of the query. To this end, the parser and/or optimizer may access a data dictionary 124 that specifies the organization, contents, and conventions of one or more databases. For example, the data dictionary 124 may specify the names and descriptions of various tables maintained by the MPP system 150 as well as fields of each database. Further, the data dictionary 124 may specify the type, length, and/or other various characteristics of the stored tables. Further, the optimizer may utilize statistics for making query assessments during construction of the query-execution plan. For example, database statistics may be used by the optimizer to determine data demographics, such as attribute minimum and maximum values and data ranges of the database. The database system typically receives queries in a standard format, such as the Structured Query Language (SQL) put forth by the American National Standards Institute (ANSI). The parsing engine 120 and data dictionary 124 may be implemented as computer-executable instruction sets tangibly embodied on a computer-readable medium, such as a memory device 142, that are retrieved by a processing module 140 and processed thereby.

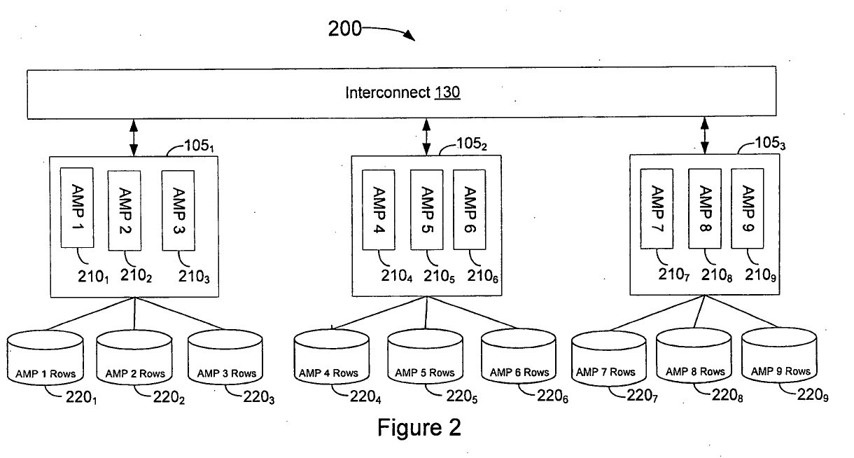

FIG. 2 is a diagrammatic representation of an MPP configuration 200 suitable for implementing mechanisms for optimizing query performance and eliminating unnecessary self-joins in accordance with disclosed embodiments. In the illustrative example, each of the processing nodes 105₁-105₃ are each configured with three respective AMPs 210₁-210₉. The rows 115_{1 . . . Y} of tables have been distributed across the nine AMPs 210₁-210₉ hosted by processing nodes 105₁-105₃ such that each of the AMPs is allocated rows 220₁-220₉.

Although the system and configuration depicted in FIGS. 1 and 2 are representative of a massively parallel processing system and a database management system deployed thereon, such a description is only provided to facilitate a discussion of disclosed embodiments. The mechanisms described herein for optimizing queries may be implemented on any variety of database management systems including single node/processor systems.

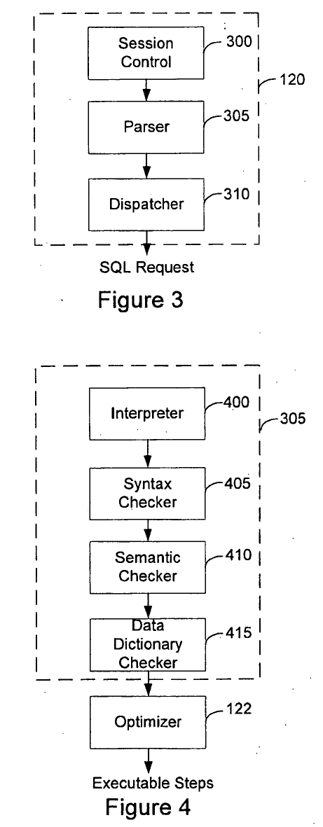

In one example system, the parsing engine 120 is made up of three components: a session control 300, a parser 305, and a dispatcher 310 as shown in FIG. 3. The session control 300 provides the logon and logoff functions. It accepts a request for authorization to access the database, verifies it, and then either allows or disallows the access. Once the session control 300 allows a session to begin, a user may submit a SQL request that is routed to the parser 305. As illustrated in FIG. 4, the parser 305 interprets the SQL request (block 400), checks the request for correct SQL syntax (block 405), evaluates the request semantically (block 410), and consults a data dictionary to ensure that all of the objects specified in the SQL request exist and that the user has the authority to perform the request (block 415). Finally, the parser 305 runs the optimizer 122 that selects the least expensive plan to perform the request.

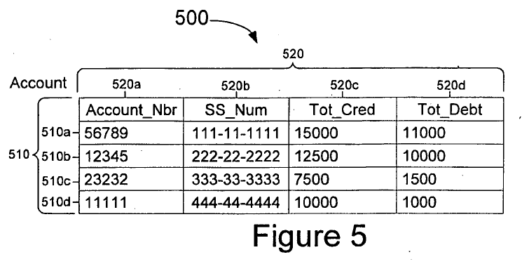

FIG. 5 is a diagrammatic representation of an exemplary table 500 on which query optimization may be performed in accordance with disclosed embodiments. Table 500 comprises a plurality of records 510a-510d (collectively referred to as records 510) and fields 520a-520d (collectively referred to as fields 520). Each record 510 comprises data elements in respective fields 520. In the present example, table 500 has a table name “Account” and includes fields 520 having respective labels of “Account_Nbr”, “SS_Num”, “Tot_Cred”, and “Tot_Debt”.

Consider an exemplary query for providing available credit for account holders:

```
SELECT
    T.“Account_Nbr”
    ,T.“SS_Num”
    ,(T.Tot_Cred−AP1.Tot_Debt
    ) AS Available_Credit
FROM “account” T
LEFT OUTER JOIN “account” AP1
ON AP1.“Account_Nbr” = T.“Account_Nbr”
AND AP1.“SS_Num” = T.“SS_Num”;
```

Self outer join operations similar to the above may often be produced by a database application or tool. In accordance with disclosed embodiments, a self outer join may be advantageously re-written to a self inner join in particular scenarios. Left outer joins require mechanisms that track rows from the left table that do not match a row from the right table. Right outer joins and full outer joins require similar resources. Such mechanisms consume memory space and processing resources. Thus, re-writing a self outer join as a self inner join provides an improvement in the query processing.

Consider a self left outer join, for example, performed on a table R on join predicates (R₁.J₁₁=R₂.J₁₁ . . . and . . . R₁.J₁ₙ=R₂.J₁ₙ) where both R₁ and R₂ are aliases for table R, and J₁₁, . . . J₁ₙ are attributes from R. In this instance, each join predicate respectively involves a common join attribute, e.g., the join predicate R₁.J₁₁=R₂.J₁₁ involves a common join attribute J₁₁. Assume there are “NOT NULL” constraints on the join attributes J₁₁-J₁ₙ. Because for any row in R there is at least one matching row (itself) from R, the left outer join can be rewritten to an inner join. For the example query, assume there are “NOT NULL” constraints on the join attributes Account_Nbr and SS_Num. Accordingly, the self left outer join may then be rewritten to a self inner join according to the following:

```
SELECT
    T.“Account_Nbr”
    ,T.“SS_Num”
    ,(T.Tot_Cred−AP1.Tot_Debt) AS Available_Credit
FROM “account” T
INNER JOIN “account” AP1
ON AP1.“Account_Nbr” = T.“Account_Nbr”
AND AP1.“SS_Num” = T.“SS_Num”;
```

This query rewriting mechanism is applicable to self right outer joins and self full outer joins as well.

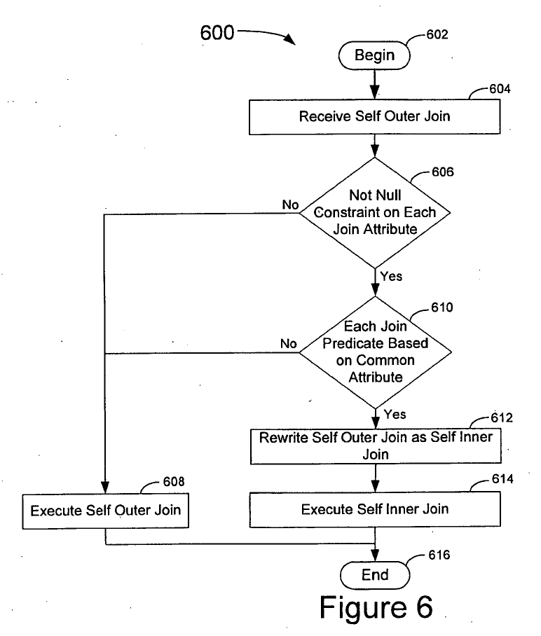

FIG. 6 is a flowchart 600 that depicts processing of a conversion routine that rewrites a self outer join to a self inner join in accordance with an embodiment. The processing steps of FIG. 6 may be implemented as computer-executable instructions tangibly embodied on a computer-readable medium executable by a processing system, such as the processing module 140 depicted in FIG. 1.

The conversion routine is invoked (step 602), and a self outer join is received (step 604). An evaluation may then be made to determine if not null constraints are associated with each join attribute (step 606). For example, the data dictionary 124 may be interrogated to evaluate the join attributes to determine if each join attribute of the self outer join has a not null constraint applied thereto. In the event that a not null constraint is not placed on each join attribute, the self outer join may then be executed (step 608), and the conversion routine cycle may then end (step 616).

Returning again to step 606, in the event that a not null constraint is placed on each join attribute, an evaluation may then be made to determine if each join predicate is respectively based on a common attribute (step 610). If each join predicate is not based on a respective common attribute, the self outer join may then be executed according to step 608.

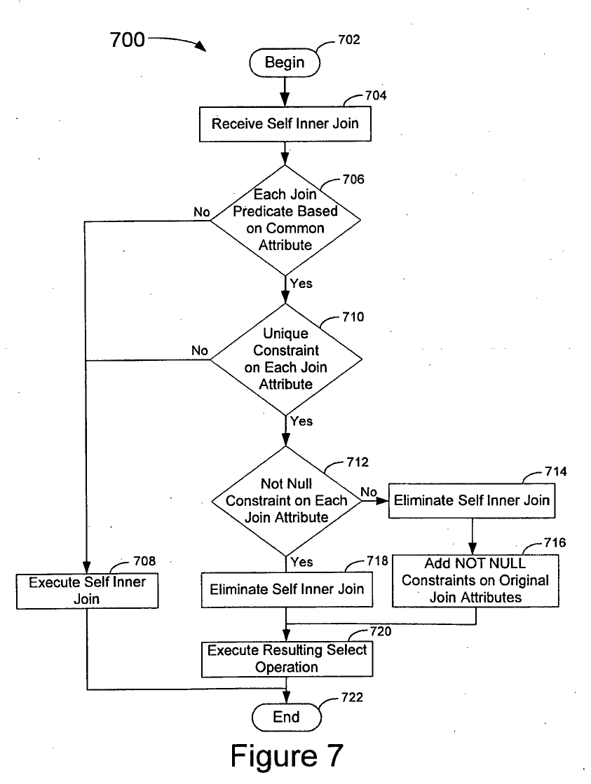

If each join predicate is respectively based on a common attribute, the self outer join may then be rewritten as a self inner join (step 612), and the self inner join may then be executed (step 614). Alternatively, the self inner join may be evaluated to determine if the self inner join may be removed in accordance with an embodiment as described more fully hereinbelow with reference to FIG. 7. The join conversion routine cycle may then end according to step 616.

In accordance with embodiments, a self inner join may advantageously be eliminated in particular scenarios. Consider a self inner join on a table R according to join predicates (R₁.J₁₁=R₂.J₁₁ . . . and . . . R₁.J₁ₙ=R₂.J₁ₙ) where both R₁ and R₂ are aliases for R, and J₁₁, . . . J₁ₙ are attributes from R. In this instance, each join predicate respectively involves a common join attribute, e.g., the join predicate R₁.J₁₁=R₂.J₁₁ involves a common join attribute J₁₁. Assume there are unique constraints on the join attributes J₁₁-J₁ₙ. Thus, for any row in R there is at most one matching row (itself) from R. Accordingly, the inner join may be eliminated. For the example query, assume there are unique constraints on the join attributes Account_Nbr and SS_Num. Therefore, the self inner join can be removed. However, since self inner-joining removes rows with NULL values in the join attributes, a WHERE condition may be added to the query to remove rows with NULL values in the join attributes after eliminating the self inner join. After properly renaming attributes in the select clause if necessary, the following simplified query may be obtained in accordance with disclosed embodiments:

```
SELECT
    T.“Account_Nbr”
    ,T.“SS_Num”
    ,( T.Tot_Cred − T.Tot_Debt) AS Available_Credit
FROM “account” T
WHERE NOT (Account_Nbr is null or SS_Num is null)
```

If, however, the inner join evaluation is performed subsequent to the outer join evaluation described above with reference to FIG. 6, NOT NULL constraints have already been identified as applied to the join attributes. In this instance, it is not necessary to include the WHERE NOT null constraints to the resulting SELECT operation thereby resulting in the following for the above exemplary query:

```
SELECT
    T.“Account_Nbr”
    ,T.“SS_Num”
    ,( T.Tot_Cred − T.Tot_Debt) AS Available_Credit
FROM “account” T
```

FIG. 7 is a flowchart 700 that depicts processing of a join conversion routine that eliminates unnecessary self inner joins in accordance with another embodiment. The processing steps of FIG. 7 may be implemented as computer-executable instructions tangibly embodied on a computer-readable medium executable by a processing system, such as the processing module 140 depicted in FIG. 1.

The conversion routine is invoked (step 702), and a self inner join is received (step 704). An evaluation is then made to determine if each join predicate is respectively based on a common attribute (step 706). If each join predicate is not based on a respective common attribute, the self inner join may then be executed according to step 708, and the join conversion routine cycle may then end (step 722).

Returning again to step 706, if each join predicate is respectively based on a common attribute, an evaluation may then be made to determine if there is a unique constraint placed on each join attribute (step 710), e.g., by interrogating the data dictionary 124. If there is not a unique constraint placed on each join attribute, the self inner join may then be executed according to step 708.

Returning again to step 710, if it is determined that there is a unique constraint placed on each join attribute, an evaluation may be made to determine if a not null constraint is associated with each join attribute (step 712). If a not null constraint is not applied to each join attribute, the self inner join may be eliminated (step 714) thereby resulting in a select operation, and a not null constraint may be added to the select statement on the join attributes of the original inner join (step 716). The resulting select operation may then be executed (step 720). If it is determined that a not null constraint is applied to each join attribute at step 712, the self inner join may then be eliminated (step 718), and the resulting select operation may then be executed according to step 720. The conversion routine cycle may then end according to step 722.

As described, mechanisms for optimizing query performance in a database system are provided. In one embodiment, join predicates of a self outer join are evaluated. If each join predicate is respectively based on a common join attribute, and each join attribute has a not null constraint applied thereto, the self outer join may be re-written as a self inner join advantageously resulting in less consumption of system resources and general query performance optimization. In another embodiment, if not null and unique constraints are applied to each join attribute of an inner join featuring join predicates each respectively based on a common join attribute, the inner join may advantageously removed thereby resulting in a select operation.

The flowcharts of FIGS. 6-7 depict process serialization to facilitate an understanding of disclosed embodiments and are not necessarily indicative of the serialization of the operations being performed. In various embodiments, the processing steps described in FIGS. 6-7 may be performed in varying order, and one or more depicted steps may be performed in parallel with other steps. Additionally, execution of some processing steps of FIGS. 6-7 may be excluded without departing from embodiments disclosed herein.

The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the disclosed embodiments may be implemented in software, hardware, firmware, or a combination thereof. The various elements of the system, either individually or in combination, may be implemented as a computer program product tangibly embodied in a machine-readable storage device for execution by a processing unit. Various steps of embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying aspects of the disclosed embodiments can be loaded onto a computer. The computer program is not limited to any particular embodiment, and may, for example, be implemented in an operating system, application program, foreground or background process, or any combination thereof, executing on a single processor or multiple processors. Additionally, various steps of embodiments may provide one or more data structures generated, produced, received, or otherwise implemented on a computer-readable medium, such as a memory.

Although disclosed embodiments have been illustrated in the accompanying drawings and described in the foregoing description, it will be understood that embodiments are not limited to the disclosed examples, but are capable of numerous rearrangements, modifications, and substitutions without departing from the disclosed embodiments as set forth and defined by the following claims. For example, the capabilities of the disclosed embodiments can be performed fully and/or partially by one or more of the blocks, modules, processors or memories. Also, these capabilities may be performed in the current manner or in a distributed manner and on, or via, any device able to provide and/or receive information. Still further, although depicted in a particular manner, a greater or lesser number of modules and connections can be utilized with the present disclosure in order to accomplish embodiments, to provide additional known features to present embodiments, and/or to make disclosed embodiments more efficient. Also, the information sent between various modules can be sent between the modules via at least one of a data network, an Internet Protocol network, a wireless source, and a wired source and via a plurality of protocols.

What is claimed is:

1. A method of optimizing processing in a database system, comprising:
receiving a self outer join operation on a database table that includes one or more join predicates;
determining a not null constraint is applied to each join attribute of the one or more join predicates;
determining each of the one or more join predicates is respectively based on a common join attribute; and
rewriting the self outer join operation as a self inner join operation.

2. The method of claim 1, wherein determining a not null constraint is applied to each join attribute comprises evaluating not null constraints associated with the table that are specified in a data dictionary.

3. The method of claim 1, further comprising determining a unique constraint is applied to each join attribute of the self inner join operation.

4. The method of claim 3, further comprising eliminating the self inner join thereby producing a select operation.

5. The method of claim 4, further comprising executing the select operation.

6. The method of claim 1, further comprising determining a unique constraint is not applied to each join attribute of the self inner join operation.

7. The method of claim 6, further comprising executing the self inner join operation.

8. A computer-readable medium having computer-executable instructions for execution by a processing system, the computer-executable instructions for optimizing processing in a database system, the computer-executable instructions, when executed, cause the processing system to:
receive a self outer join operation on a database table that includes one or more join predicates;
determine a not null constraint is applied to each join attribute of the one or more join predicates;
determine each of the one or more join predicates is respectively based on a common join attribute; and
rewrite the self outer join operation as a self inner join operation.

9. The computer-readable medium of claim 8, wherein the instructions that determine a not null constraint is applied to each join attribute comprise instructions that, when executed, cause the processing system to evaluate not null constraints associated with the table that are specified in a data dictionary.

10. The computer-readable medium of claim 8, further comprising instructions that, when executed, cause the processing system to determine a unique constraint is applied to each join attribute of the self inner join operation.

11. The computer-readable medium of claim 10, further comprising instructions that, when executed, cause the processing system to eliminate the self inner join thereby producing a select operation.

12. The computer-readable medium of claim 11, further comprising instructions that, when executed, cause the processing system to execute the select operation.

13. The computer-readable medium of claim 8, further comprising instructions that, when executed, cause the processing system to determine a unique constraint is not applied to each join attribute of the self inner join operation.

14. The computer-readable medium of claim 8, further comprising instructions that, when executed, cause the processing system to execute the self inner join operation.

15. A database management system, comprising:
a storage facility on which a database table is stored; and
a processing module that receives a self outer join operation that includes one or more join predicates, determines a not null constraint is applied to each join attribute of the one or more join predicates, determines each of the one or more join predicates is respectively based on a common join attribute, and rewrites the self outer join operation as a self inner join operation.

16. The system of claim 15, wherein the system further comprises a data dictionary maintained on a storage facility, and wherein the processing module determines a not null constraint is applied to each join attribute by evaluating not null constraints associated with the table that are specified in the data dictionary.

17. The system of claim 15, wherein the processing module determines a unique constraint is applied to each join attribute of the self inner join operation.

18. The system of claim 17, wherein the processing module eliminates the self inner join thereby producing a select operation.

19. The system of claim 18, wherein the processing module executes the select operation.

20. The system of claim 15, wherein the processing module determines a unique constraint is not applied to each join attribute of the self inner join operation and, responsive thereto, executes the self inner join operation.
